(19) United States
(12) Patent Application Publication
(10) Pub. No.: US 2026/0152703 A1
(43) Pub. Date: Jun. 4, 2026

(54) AUTOMATIC DISHWASHING DETERGENT COMPOSITION THAT IS SUITABLE FOR AUTO-DOSING INTO AN AUTOMATIC DISHWASHING APPLIANCE

(71) Applicant: The Procter & Gamble Company, Cincinnati, OH (US)

(72) Inventors: Lindsay Suzanne BEWICK, Tyne & Wear (GB); Vania Cristina CROCE MAGO, Newcastle upon Tyne (GB); Patrick Firmin August DELPLANCKE, Steenhuize-Wijnhuize (BE); Zoe Esther WATTS, Northumberland (GB)

(21) Appl. No.: 19/392,358

(22) Filed: Nov. 18, 2025

(30) Foreign Application Priority Data
Nov. 29, 2024 (EP) 24216339.2

(51) Int. Cl. C11D 3/395; C11D 1/72; C11D 1/825; C11D 3/22; C11D 3/33; C11D 3/43

(52) U.S. Cl. CPC C11D 3/3956; C11D 1/72; C11D 1/825; C11D 3/222; C11D 3/33; C11D 3/43; C11D 2111/14

(57) ABSTRACT

An automatic dishwashing detergent composition suitable for auto-dosing into an automatic dishwashing appliance is provided. The composition includes a combination of at least a first liquid component and a second liquid component that are contained separately from one another within a water insoluble packaging. The first liquid component includes phthalimidoperoxycaproic acid bleach and water and has a pH of less than 7.0. The second liquid component includes non-ionic surfactant.

### FIELD OF THE INVENTION

The present invention relates to an automatic dishwashing detergent composition that is suitable for auto-dosing into an automatic dishwashing appliance.

### BACKGROUND OF THE INVENTION

Dishwashing detergent compositions are used in automatic dishwashing appliances to provide numerous benefits, including a good cleaning profile and a good shine profile. The dishwashing detergent compositions have conventionally been provided to the automatic dishwashing appliance either through the consumer pouring dishwashing detergent liquid or powder directly into the dishwashing appliance, or directly placing a dishwashing detergent tablet or water-soluble pouch into the dishwashing appliance.

However, conventional detergent liquids, powders, tablets, and pouches do not have a way to dose discrete chemicals to the dishwashing appliance independently of each other. Providing chemicals to the dishwashing appliance separately from each other allow the dishwashing appliance to administer the chemicals separately and at different times of the treatment cycle and allow for chemicals that may not otherwise be stable in the presence of each other to be provided in one container.

Dishwashing detergent manufacturers and automatic dishwashing appliance manufacturers are designing systems that can deliver specific detergent ingredients at specific times of the treatment cycle by means of automatically dosing ingredients at numerous points in time during the treatment cycle.

The present invention provides automatic dishwashing detergent composition suitable for auto-dosing into an automatic dishwashing appliance, the composition comprising a combination of at least two liquid components that are contained separately from one another within a water insoluble packaging.

The composition of the present invention provides excellent shine performance and excellent anti-grit performance.

### SUMMARY OF THE INVENTION

The present invention provides, in an example, an automatic dishwashing detergent composition suitable for auto-dosing into an automatic dishwashing appliance, the composition comprising a combination of at least two liquid components that are contained separately from one another within a water insoluble packaging, wherein:
(a) the first liquid component:
   (i) comprises at least 5.0wt % phthalimidoperoxycaproic acid bleach;
   (ii) comprises greater than 20 wt % water; and
   (iii) has a pH of less than 7.0 when measured neat at a temperature of 20° C.; and
(b) the second liquid component comprises greater than 50 wt % non-ionic surfactant.

### DETAILED DESCRIPTION OF THE INVENTION

### An Automatic Dishwashing Detergent Composition.

The automatic dishwashing detergent composition is suitable for auto-dosing into an automatic dishwashing appliance. The composition comprises a combination of at least two liquid components that are contained separately from one another within a water insoluble packaging. The composition comprises a first liquid component and a second liquid component. These liquid components are described in more detail below. The composition may, and preferably does, comprise additional liquid components. Preferably, the composition comprises a third liquid component and/or a fourth liquid component. These liquid components are also described in more detail below. Typically, all liquid components are contained separately from each other within a water-insoluble packaging. The water-insoluble packaging is also described in more detail below. A preferred water-insoluble packaging is in the form of a cartridge. The cartridge is described in more detail below. The composition typically comprises detergent ingredients. Suitable detergent ingredients are described in more detail below.

### First Liquid Component.

The first liquid component:
(i) comprises at least 5.0wt % phthalimidoperoxycaproic acid bleach;
(ii) comprises greater than 20 wt % water; and
(iii) has a pH of less than 7.0 when measured neat at a temperature of 20° C.

Preferably, the first liquid component comprises from greater than 5.0 to 30 wt %, or from 5.5 wt % to 30 wt %, or from 5.5 wt % to 25 wt %, or from 6.0wt % to 25 wt %, or from 6.0wt % to 20 wt %, or from 6.5 wt % to 20 wt %, or from 7.0wt % to 20 wt %, or from 7.5 wt % to 20 wt %, or from 8.0wt % to 20 wt %, or from 8.5 wt % to 20 wt %, or from 9.0wt % to 20 wt %, or from 9.0wt % to 15 wt %, or from 9.0wt % to 25 wt %, phthalimidoperoxycaproic acid bleach.

Preferably, the first liquid component comprises from 30 wt % to less than 95 wt %, or from 40 wt % to 90 wt %, or from 50 wt % to 90 wt % water, or from greater than 50 wt % to 90 wt %, or from 60 wt % to 90 wt %, or from 50 wt % to 85 wt %, or from 55 wt % to 85 wt %, or from 60 wt % to 85 wt % water.

Preferably, the first liquid component has a pH, when measured neat at a temperature of 20° C., in the range of from 2.0 to 6.0, or from 2.0 to 5.5, or from 2.0 to 5.0, or from 2.5 to 4.5, or from 2.5 to 4.0, or from 3.0 to 4.0.

The first liquid component may comprise additional detergent ingredients. Suitable detergent ingredients are described in more detail below.

The first liquid component is preferably free of enzyme. The first liquid component may comprise a chelant. The first liquid component may comprise from 0.1wt % to 5.0wt % chelant. Suitable chelants are described in more detail below. The first liquid component preferably comprises 1-hydroxy ethylene-1,1-diphosphonic acid (HEDP). The first liquid component may comprise from 0.1 wt % to 5.0wt % 1-hydroxy ethylene-1,1-diphosphonic acid (HEDP). The first liquid component may comprise xanthan gum. The first liquid component may comprise from 0.1 wt % to 5.0wt % xanthan gum.

The first liquid component may comprise aminopolycarboxylic acid and/or salt thereof builder. The first liquid component may comprise from 5.0wt % to 30 wt % aminopolycarboxylic acid and/or salt thereof builder. Suitable aminopolycarboxylic acids and/or salts thereof are selected from methylglycine-N,N-diacetic acid and/or salts thereof (MGDA), glutamic acid diacetic acid and/or salts thereof (GLDA), iminodisuccinic acid and/or salts thereof (IDS); hydroxyethyleiminodiacetic acid and/or salts thereof (HEIDA), and any combination thereof, preferably methylglycine-N,N-diacetic acid and/or salts thereof (MGDA) and/or glutamic acid diacetic acid and/or salts thereof (GLDA), most preferably methylglycine-N,N-diacetic acid and/or salts thereof (MGDA). A suitable builder complexing agent is the tri-sodium salt of methylglycine-N,N-diacetic acid.

Another suitable aminopolycarboxylic acid and/or salts thereof is ethylene diamine disuccinic acid and/or salts thereof (EDDS).

### Second Liquid Component.

The second liquid component comprises greater than 50 wt % non-ionic surfactant, preferably greater than 55 wt %, or greater than 60 wt %, or greater than 65 wt %, or greater than 67 wt %, or greater than 70 wt %, or even greater than 75 wt % non-ionic surfactant. Suitable non-ionic surfactants are described in more detail below.

Preferably, the second liquid component comprises a surfactant selected from:
(i) R—O-EOₓH, wherein R is a C₆-C₁₈ alkyl, and x is from 1 to 30; or
(ii) R—O-EOₓPO_{y}H, wherein R is a C₆-C₁₈ alkyl, x is from 1 to 20, and y is from 1 to 20; or
(iii) R—O—POₓEO_{y}H, wherein R is a C₆-C₁₈ alkyl, x is from 1 to 20, and y is from 1 to 20; or
(iv) R—O— EOₓPO_{y}EO_{z}H, wherein R is a C₆-C₁₈ alkyl, x is y from 1 to 20, y is from 1 to 20, and z is from 1 to 20; or
(v) R—O— POₓEO_{y}PO_{z}H, wherein R is a C₆-C₁₈ alkyl, x is from 1 to 20, y is from 1 to 20, and z is from 1 to 20; or
(vi) HO— EOₓPO_{y}EO_{z}H, wherein, x is from 1 to 50, y is from 1 to 50, and z is from 1 to 50; or
(vii) HO— POₓEO_{y}PO_{z}H, wherein x is from 1 to 50, y is from 1 to 50, and z is from 1 to 50; or
(viii) R—O-EOₓBO_{y}H, wherein R is a C₆-C₁₈ alkyl, x is from 1 to 20, and y is from 1 to 20; or
(ix) R—O—BOₓEO_{y}H, wherein R is a C₆-C₁₈ alkyl, x is from 1 to 20, and y is from 1 to 20; or
(x) any combination thereof.

For the above surfactants (i) to (v) above, the alkyl moiety can be linear or branched, and can be derived from a guerbet alcohol, or can derived from an oxo-alcohol.

Preferably, the second liquid component comprises a surfactant selected from:
(i) R—O-EOₓH, wherein R is a C₆-C₁₈ alkyl, and x is from 1 to 30; and/or
(ii) R—O— POₓEO_{y}PO_{z}H, wherein R is a C₆-C₁₈ alkyl, x is y from 1 to 20, y is from 1 to 20, and z is from 1 to 20.

Preferably, the second liquid component comprises from 30 wt % to 50 wt % of a surfactant selected from R—O-EOₓH, wherein R is a C₆-C₁₈ alkyl, and x is from 1 to 30. Preferably, the second liquid component comprises from 25 wt % to 45 wt % of a surfactant selected from R—O—POₓEO_{y}PO_{z}H, wherein R is a C₆-C₁₈ alkyl, x is y from 1 to 20, y is from 1 to 20, and z is from 1 to 20.

Preferably, the second liquid component is anhydrous.

Preferably, the second liquid component comprises solvent. Suitable solvents are described in more detail below. Preferably, the second liquid component comprises solvent selected from alkanolamines, polyethers, polyols, and any combination thereof. Preferably, the second liquid component comprises from 10 wt % to 30 wt % dipropyleneglycol.

The second liquid component may comprise aminopolycarboxylic acid and/or salt thereof builder.

Typically, the second liquid component has a pH of greater than 8.0, or greater than 8.5, or greater than 9.0, and preferably from greater than 8.0 to 12.0, or from greater than 8.0 to 11.0, or from greater than 8.5 to 10.5, when measured neat at a temperature of 20° C.

### Optional Third Liquid Component.

The composition may comprise an optional third liquid component. The third liquid component:
(i) comprises greater than 0.1wt %, based on an active enzyme basis, protease and/or amylase;
(ii) comprises greater than 20 wt % water; and
(iii) has a pH of less than 8.0, when measured neat at a temperature of 20° C.

Suitable protease and suitable amylase are described in more detail below. Preferably, the third liquid component comprises both protease and amylase.

Preferably, the combined total amount of protease and amylase present in the third liquid component, based on an active enzyme basis, is the range of from greater than 0.1 wt % to 20 wt %, or from greater than 0.1wt % to 15 wt %, 10wt %, or from greater than 0.1wt % to 8.0wt %, or from greater than 0.1wt % to 5.0wt %, or from 0.2 wt % to 10wt %, or from 0.5 wt % to 10 wt %, or from 0.2 wt % to 5.0wt %, or from 0.5 wt % to 5.0wt %.

Preferably, the third liquid component comprises greater than 0.5 wt %, or greater than 1.0wt %, or greater than 1.5 wt %, or greater than 2.0wt %, or greater than 2.5 wt %, greater than 3.0wt %, based on an active enzyme basis, protease.

Preferably, the third liquid component comprises greater than 0.1 wt %, or greater than 0.2 wt %, or greater than 0.3 wt %, or greater than 0.4 wt %, or greater than 0.5 wt %, based on an active enzyme basis, amylase.

Preferably, the third liquid component comprises greater than 30%, or greater than 40 wt %, or greater than 50 wt %, or greater than 60 wt %, or greater than 70 wt %, or greater than 80 wt % water.

The third liquid component preferably has a pH, when measured neat at a temperature of 20° C., in the range of from 6.0 to less than 8.0, or from 6.0 to 7.5, or from 6.5 to 7.5, or from 6.5 to 7.0.

The third liquid component may comprise additional detergent ingredients. Suitable detergent ingredients are described in more detail below. Preferably, the third liquid component is free of bleach. The third liquid component may comprise solvent. The third liquid component may comprise from 0.1wt % to 5.0 wt % solvent. Suitable solvents are described in more detail below.

### Optional Fourth Liquid Component.

The composition may comprise an optional fourth liquid component. The fourth liquid component:
(i) comprises greater than 10wt % aminopolycarboxylic acid and/or salt thereof builder;
(ii) comprises greater than 20 wt % water; and
(iii) has a pH of greater than 8.0, when measured neat at a temperature of 20° C.

Preferably, the fourth liquid component comprises from greater than 10 wt % to 60 wt %, or from 12 wt % to 50 wt %, or from 15 wt % to 40 wt %, or from 20 wt % to 30 wt % aminopolycarboxylic acid and/or salt thereof builder.

Suitable aminopolycarboxylic acids and/or salts thereof are selected from methylglycine-N,N-diacetic acid and/or salts thereof (MGDA), glutamic acid diacetic acid and/or salts thereof (GLDA), iminodisuccinic acid and/or salts thereof (IDS); hydroxyethyleiminodiacetic acid and/or salts thereof (HEIDA), and any combination thereof, preferably methylglycine-N,N-diacetic acid and/or salts thereof (MGDA) and/or glutamic acid diacetic acid and/or salts thereof (GLDA), most preferably methylglycine-N,N-diacetic acid and/or salts thereof (MGDA). A suitable builder complexing agent is the tri-sodium salt of methylglycine-N,N-diacetic acid.

Another suitable aminopolycarboxylic acid and/or salts thereof is ethylene diamine disuccinic acid and/or salts thereof (EDDS).

Preferably, the fourth liquid component comprises methylglycinediacetic acid and/or salt thereof (MGDA). Preferably, the fourth liquid component comprises from greater than 10 wt % to 60 wt %, or from 12 wt % to 50 wt %, or from 15 wt % to 40 wt %, or from 20 wt % to 30 wt % methylglycinediacetic acid and/or salt thereof (MGDA).

Preferably, the fourth liquid component comprises tri-sodium salt of methylglycine-N,N-diacetic acid. Preferably, the fourth liquid component comprises from greater than 10 wt % to 60 wt %, or from 12 wt % to 50 wt %, or from 15 wt % to 40 wt %, or from 20 wt % to 30 wt % tri-sodium salt of methylglycine-N,N-diacetic acid.

Preferably, the fourth liquid component comprises from greater than 20 wt % to less than 90 wt %, or from greater than 20 wt % to 85 wt %, or from 25 wt % to 80 wt %, or from 25 wt % to 70 wt %, or from 30 wt % to 60 wt % water.

Preferably, the fourth liquid component has a pH, when measured neat at a temperature of 20° C., in the range of from greater than 8.0 to 14, or from 8.5 to 14, or from 9.0 to 14, or from 9.5 to 14, or from 10 to 14, or from 11 to 14, or from 12 to 14.

The fourth liquid component may comprise additional detergent ingredients. Suitable detergent ingredients are described in more detail below. Preferably, the fourth liquid component is free of enzymes.

Preferably, the fourth liquid component comprises potassium carbonate. Preferably, the fourth liquid component comprises from 10wt % to 40 wt %, or from 15 wt % to 35 wt %, or from 20 wt % to 30 wt % potassium carbonate.

Preferably, the fourth liquid component comprises sodium disilicate. Preferably, the fourth liquid component comprises from 0.1 wt % to 10 wt %, or from 0.5 wt % to 5.0 wt %, or from 0.5 wt % to 3.0wt %, or from 1.0 to 3.0wt % sodium disilicate.

Preferably, the fourth liquid component comprises carboxylate polymer. Preferably, the fourth liquid component comprises sulphonated carboxylate polymer. Preferably, the fourth liquid component comprises from 0.1wt % to 10wt %, or from 0.5 wt % to 5.0wt %, or from 0.5 wt % to 3.0wt %, or from 1.0 to 3.0wt % carboxylate polymer. Preferably, the fourth liquid component comprises from 0.1 wt % to 10 wt %, or from 0.5 wt % to 5.0wt %, or from 0.5 wt % to 3.0wt %, or from 1.0 to 3.0wt % sulphonated carboxylate polymer. Suitable carboxylate polymers, and sulphonated carboxylate polymers, are described in more detail below.

### Detergent Ingredients.

Suitable detergent ingredients can be described in terms of systems. The composition typically comprises one or more of an alkalinity system, a bleach system, a builder system, a chelant system, an enzyme system, a polymer system, and a surfactant system. Suitable detergent ingredients can also include other detergent ingredients.

### Alkalinity System.

The alkalinity system typically achieves the target pH profile of the composition and/or liquid components. The pH profile of the composition and/or liquid components impact the cleaning profile of the composition. Alkalinity typically provides soil swelling and soil dispersion performance, as well as providing the optimal pH for other detergent ingredients to work, such as the bleach system, builder system, chelant system and enzyme system.

The amount of alkalinity system is typically determined by the desired pH profile of the composition and/or liquid components.

Any suitable source of alkalinity can be used. Suitable sources of alkalinity are organic alkaline ingredients and inorganic alkaline ingredients. A suitable alkalinity source is selected from carbonate salts, silicate salts, and sources of hydroxide anions.

A suitable alkalinity source is carbonate salt. Preferred carbonate salts are selected from alkali metal salts of carbonate and/or alkaline earth metal salts of carbonate. Preferred carbonate salts are selected from magnesium carbonate, potassium carbonate, sodium carbonate, and any combination thereof, most preferably potassium carbonate.

A suitable alkalinity source is silicate salt. Preferred silicate salts are selected from alkali metal salts of silicate and/or alkaline earth metal salts of silicate. Preferred silicate salts are selected from magnesium silicate, potassium silicate, sodium silicate, and any combination thereof, most preferably sodium silicate. Preferred sodium silicates have a weight ratio SiO₂ to Na₂O ratio of from 1.0:1 to 3.5:1, preferably from 1.5:1 to 2.5:1, most preferably 2.0:1 (sodium disilicate).

A suitable alkalinity source is a source of hydroxide. Preferred sources of hydroxide are selected from alkali metal hydroxide and/or alkaline earth metal hydroxide. Preferred sources of hydroxide are selected from magnesium hydroxide, potassium hydroxide, sodium hydroxide, and any combination thereof, most preferably sodium hydroxide.

### Bleach System.

Typically, the bleach system provides cleaning and disinfection benefits. The bleach system typically comprises a source of peroxygen, often in combination with a bleach activator and/or a bleach catalyst.

Any suitable source of peroxygen can be used. A suitable source of peroxygen is a perhydrate salt, especially alkali metal perhydrate salts and/or alkaline earth metal perhydrate salts, preferably alkali metal perhydrate salts. Suitable perhydrate salts are selected from perborate salt, percarbonate salt, perphosphate salt, persilicate salt, persulfate salt and any combination thereof.

The perhydrate salt may be a crystalline solid without additional protection. Alternatively, the perhydrate salt can be coated. Suitable coatings are selected from sodium carbonate, sodium silicate, sodium sulphate, and any combination thereof.

A preferred perhydrate salt is an alkali metal percarbonate, especially preferred is sodium percarbonate. The percarbonate is preferably in a coated form. The coating provides in-product stability.

Another suitable source of peroxygen is a pre-formed peracid. A preferred pre-formed peracid is phthalimidoperoxycaproic acid (PAP).

Any suitable bleach activator can be used. Bleach activators are typically used to enhance the bleaching performance at temperatures of 60° C. and below.

A suitable bleach activator is an organic peracid precursor. Suitable bleach activators are compounds which, under perhydrolysis conditions, give aliphatic peroxycarboxylic acids having preferably from 1 to 12 carbon atoms, in particular from 2 to 10 carbon atoms, and/or optionally substituted perbenzoic acid. Suitable bleach activators comprise O-acyl and/or N-acyl groups of the number of carbon atoms specified and/or optionally substituted benzoyl groups. Preferred bleach activators are polyacylated alkylenediamines. A highly preferred bleach activator is tetraacetylethylenediamine (TAED).

Any suitable bleach catalyst can be used. Suitable bleach catalysts are metal-containing bleach catalysts, preferably transition-metal-containing bleach catalysts. Preferred transition-metal-containing bleach catalysts are selected from cobalt-containing bleach catalysts, iron-containing bleach catalysts, manganese-containing bleach catalysts, and any combination thereof.

Suitable manganese-containing bleach catalysts comprise manganese in an oxidation state of (II), (III), (IV), (v), or any combination thereof, preferably (IV). Suitable manganese-containing bleach catalyst includes manganese triazacyclononane and related complexes, such as 1,4,7-triazacyclononane (TACN).

### Builder System.

The builder system typically comprises detergent ingredients that are complexing agents. Suitable builder complexing agents are capable of sequestering hardness cations, especially calcium cations and/or magnesium cations. Typically, the builder system controls the hardness of the wash liquor, which in turn aids the cleaning performance and soil suspension performance of the composition. The builder system can also extract calcium and magnesium cations from the soil, which also improves the cleaning performance of the composition.

Any suitable builder complexing agent can be used. Suitable builder complexing agents may also be able to complex other cations, such as transition metal cations.

A preferred builder complexing agent is selected from aminopolycarboxylic acids and/or salts thereof, carboxylic acids and/or salts thereof, and any combination thereof.

Suitable aminopolycarboxylic acids and/or salts thereof are selected from methylglycine-N,N-diacetic acid and/or salts thereof (MGDA), glutamic acid diacetic acid and/or salts thereof (GLDA), iminodisuccinic acid and/or salts thereof (IDS); hydroxyethyleiminodiacetic acid and/or salts thereof (HEIDA), and any combination thereof, preferably methylglycine-N,N-diacetic acid and/or salts thereof (MGDA) and/or glutamic acid diacetic acid and/or salts thereof (GLDA), most preferably methylglycine-N,N-diacetic acid and/or salts thereof (MGDA). A suitable builder complexing agent is the tri-sodium salt of methylglycine-N,N-diacetic acid. A suitable aminopolycarboxylic acid and/or salts thereof is ethylene diamine disuccinic acid and/or salts thereof (EDDS).

Suitable carboxylic acids and/or salts thereof can be dicarboxylic acids and/or salts thereof, such as glucaric acid and/or salts thereof, itaconic acid and/or salts thereof, maleic acid and/or salts thereof, succinic acid and/or salts thereof, tartaric acid and/or salts thereof, and any combination thereof. Suitable carboxylic acids and/or salts thereof can be tricarboxylic acids and/or salts thereof, A suitable carboxylic acid and/or salts thereof is citric acid and/or salts thereof. A suitable builder complexing agent is sodium citrate.

Suitable builder complexing agents can be selected from methylglycine-N,N-diacetic acid and/or salts thereof (MGDA) and/or citric acid and/or salts thereof. Suitable builder complexing agents are the combination of methylglycine-N,N-diacetic acid and/or salts thereof (MGDA) and/or citric acid and/or salts thereof. The presence of citric acid and/or salt thereof can be used in conjunction with MGDA, or independently thereof.

Any suitable methylglycine-N,N-diacetic acid and/or salt thereof (MGDA) can be used. Preferably, the MGDA is the salt form of methylglycine-N,N-diacetic acid, more preferably the MGDA is the tri-sodium salt of methylglycine-N,N-diacetic acid.

### Chelant System.

The chelant system typically comprising chelating agents. Suitable chelating agents can chelate transition metal cations, especially copper, iron and zinc. Typically, the chelant system stabilizes the bleaching system by protecting the bleach from transition metal cation degradation. The chelant system can also extract transition metal cations from soils, such as tea soils.

Any suitable chelating agent can be used. Suitable chelating agents may also be able to complex other cations, such as hardness cations like calcium and magnesium.

Suitable chelating agents are selected from phosphonic acids and/or salts thereof. Phosphonic acids and/or salts thereof typically provide crystal growth inhibition performance.

A preferred phosphonic acid and/or salts thereof is selected from: 1-hydroxy ethylidene-1,1 diphosphonic acid and/or salts thereof (HEDP), amino trimethyl phosphonic acid and/or salts thereof (ATMP), diethylene triamine pentamethylene phosphonic acid and/or salts thereof (DTMP), 2-phosphono 1,2,4-butane tricarboxylic acid and/or salts thereof (PBTC), and any combination thereof, preferably 1-hydroxy ethylidene-1,1 diphosphonic acid and/or salts thereof (HEDP). A suitable chelating agent is the tetrasodium salt of 1-hydroxy ethylidene-1,1 diphosphonic acid.

### Enzyme System.

The enzyme system provides cleaning benefits. The enzyme typically comprises an enzyme selected from amylase, cellulase, lipase, protease and any combination thereof. Preferably, the enzyme system comprises an amylase and/or a protease. In describing enzymes, the following nomenclature is used for ease of reference: Original amino acid(s):position(s):substituted amino acid(s). Standard enzyme IUPAC 1-letter codes for amino acids are used.

### Identity.

Percent sequence “identity” means that a particular sequence has at least a certain percentage of amino acid residues identical to those in a specified reference sequence, when aligned using software programs such as the CLUSTAL W algorithm with default parameters. See Thompson et al. (1994) Nucleic Acids Res. 22:4673-4680. Default parameters for the CLUSTAL W algorithm are:
Gap opening penalty: 10.0
Gap extension penalty: 0.05
Protein weight matrix: BLOSUM series
DNA weight matrix: IUB
Delay divergent sequences %: 40
Gap separation distance: 8
DNA transitions weight: 0.50
List hydrophilic residues: GPSNDQEKR
Use negative matrix: OFF
Toggle Residue specific penalties: ON
Toggle hydrophilic penalties: ON
Toggle end gap separation penalty OFF

Deletions are counted as non-identical residues, compared to a reference sequence.

### Amylase.

Suitable amylases include alpha-amylases. Suitable amylases are from bacterial or fungal origin.

A preferred alkaline alpha-amylase is derived from a strain of Bacillus, such as Bacillus amyloliquefaciens, Bacillus licheniformis, Bacillus stearothermophilus, Bacillus subtilis, or other Bacillus sp., such as Bacillus sp. 707, AA2560, DSM 9375, DSM 12368, DSM 12649, DSM 12651, KSM AP1378, KSM K36, KSM K38, NCIB 12289, NCIB 12512 or NCIB 12513.

A preferred amylase is a variant of Bacillus sp. DSM12651. A preferred amylase is a variant of Bacillus sp. DSM12651 amylase and has at least 90%, or at least 95%, or even at least 99% identity to the Bacillus sp. DSM12651 amylase wildtype sequence.

A preferred amylase is a variant of Bacillus sp. DSM 12649 amylase. A preferred amylase is a variant of Bacillus sp. DSM 12649 amylase and has at least 90%, or at least 95%, or even at least 99% identity to the Bacillus sp. DSM 12649 amylase wildtype sequence.

A preferred amylase is a variant of Bacillus sp. AA2560 amylase. A preferred amylase is a variant of Bacillus sp. AA2560 amylase and has at least 90%, or at least 95%, or even at least 99% identity to the Bacillus sp. AA2560 amylase wildtype sequence.

A preferred amylase is Bacillus sp. SP707 amylase or a variant thereof. A preferred amylase is Bacillus sp. SP707 amylase or a variant thereof, and has at least 90%, or at least 95%, or even at least 99% identity to the Bacillus sp. SP707 amylase wildtype sequence.

A preferred amylase is a variant of Bacillus sp. NCIB12513 amylase. A preferred amylase is a variant of Bacillus sp. NCIB12513 amylase and has at least 90%, or at least 95%, or even at least 99% identity to the Bacillus sp. NCIB12513 amylase wildtype sequence.

Suitable commercially available alpha-amylases include: KEMZYM® (AT 9000 Biozym Biotech Trading GmbH Wehlistrasse 27b A-1200 Wien Austria); ENZYSIZE®, OPTISIZE HT PLUS®, PURASTAR®, PURASTAR OXAM®, and RAPIDASE®, (Genencor International Inc., Palo Alto, California); KAM® (Kao, 14-10 Nihonbashi Kayabacho, 1-chome, Chuo-ku Tokyo 103-8210, Japan); BAN®, DURAMYL®, FUNGAMYL®, LIQUEZYME®, NATALASE®, POWERASE®, STAINZYME®, STAINZYME PLUS®, SUPRAMYL®, TERMAMYL®, and TERMAMYL ULTRA® (Novozymes A/S, Bagsvaerd, Denmark); and any combination thereof.

Preferred amylases include NATALASE®, POWERASE®, STAINZYME®, STAINZYME PLUS®, and any combination thereof.

### Cellulase.

Suitable cellulases include those of bacterial or fungal origin. Chemically modified or protein engineered mutants are also suitable. Suitable cellulases include cellulases from the genera Bacillus, Pseudomonas, Humicola, Fusarium, Thielavia, Acremonium, e.g., the fungal cellulases produced from Humicola insolens, Fusarium oxysporum, and Myceliophthora thermophila.

Commercially available cellulases include: Biotouch® series of enzymes (AB Enzymes); Revitalenz® series of enzymes (Du Pont); Carezyme®, Carezyme® Premium, Celluclean®, Celluzyme® and Whitezyme® (Novozymes A/S); and any combination thereof.

Suitable commercially available cellulases include Celluclean® Classic and/or Carezyme® Premium.

### Lipase.

Suitable lipases include those of bacterial, fungal or synthetic origin, and variants thereof. Chemically modified or protein engineered mutants are also suitable. Examples of suitable lipases include lipases from Humicola (synonym Thermomyces), e.g., from H. lanuginosa (T. lanuginosus).

A suitable lipase is a variant of the wild-type lipase from Thermomyces lanuginosus. Preferred lipases include those sold under the tradenames Lipex®, Lipoclean®, and Lipolex® by Novozymes, Bagsvaerd, Denmark.

Other suitable lipases include Liprl 139 and/or TfuLip2.

### Protease.

Suitable proteases include metalloproteases and serine proteases. Suitable proteases include neutral or alkaline microbial serine proteases, such as subtilisins, as well as chemically or genetically modified variants thereof.

Suitable proteases include proteases derived from Bacillus. Suitable proteases include variants of: Bacillus alcalophilus, Bacillus amyloliquefaciens, Bacillus clausii, Bacillus lentus, Bacillus gibsonii Bgi02446, Bacillus gibsonii DSM14391, Bacillus pumilus, and Bacillus subtilis.

A preferred protease is a variant of Bacillus gibsonii protease. A preferred protease is a variant of Bacillus gibsonii Bgi02446 protease or a variant of Bacillus gibsonii DSM14391 protease.

A preferred protease is a variant of Bacillus gibsonii Bgi02446 protease. A preferred protease is a variant of Bacillus gibsonii Bgi02446 protease and has at least 90%, or at least 95%, or even at least 99% identity to the Bacillus gibsonii Bgi02446 protease wildtype sequence.

A preferred protease is a variant of Bacillus gibsonii DSM14391 protease. A preferred protease is a variant of Bacillus gibsonii DSM14391 protease and has at least 90%, or at least 95%, or even at least 99% identity to the Bacillus gibsonii DSM14391 protease wildtype sequence.

A preferred protease is a variant of Bacillus alcalophilus protease. A preferred protease is a variant of Bacillus alcalophilus protease and has at least 90%, or at least 95%, or even at least 99% identity to the Bacillus alcalophilus protease wildtype sequence.

A preferred protease is a variant of Bacillus lentus protease. A preferred protease is a variant of Bacillus lentus protease and has at least 90%, or at least 95%, or even at least 99% identity to the Bacillus lentus protease wildtype sequence.

Suitable commercially available protease enzymes include those sold under the trade names Savinase®, Polarzyme®, Kannase®, Ovozyme®, Everlase® and Esperase® by Novozymes A/S (Denmark), those sold under the tradename Properase®, Purafect®, Purafect Prime®, Purafect Ox®, FN3®, FN4®, Excellase®, Ultimase® and Purafect OXP® by Genencor International, those sold under the tradename Opticlean® and Optimase® by Solvay Enzymes, those available from Henkel/Kemira, namely BLAP, and any combination thereof.

### Other Enzymes.

Other suitable enzymes are bleaching enzymes. Preferred bleaching enzymes are peroxidases/oxidases. Typical bleaching enzymes include those of plant, bacterial or fungal origin, and variants thereof. Commercially available peroxidases include Guardzyme® (Novozymes A/S).

Other suitable bleaching enzymes include choline oxidases and/or perhydrolases.

Suitable enzymes include sugar degrading enzymes. Suitable enzymes include glycosyl hydrolase. A suitable enzyme is selected from glucanase, hemicellulase, mannanase, xylanase, and any combination thereof.

Suitable mannanases are sold under the tradenames Mannastar® (Du Pont) and Mannaway® (Novozymes A/S, Bagsvaerd, Denmark).

Suitable enzymes include pectate lyases. Suitable pectate lyases are sold under the tradenames PrimaGreen® (DuPont) and X-Pect®, Pectaway® (from Novozymes A/S, Bagsvaerd, Denmark).

A suitable enzyme is phospholipase.

### Polymer System.

The polymer system can act as soil dispersant as well, as a co-builder to help complex hardness cations such as calcium and magnesium.

The polymer system typically comprises polymers. Suitable polymers are selected from modified polyamine polymers, modified polysaccharide polymers, polyalkylene oxide polymers, polycarboxylate polymers, silicone polymers, terephthalate polymers, other polyester polymers, and any combination thereof.

Preferably, the polymer system comprises polymers selected from polyamine polymers, modified polysaccharide polymers, polyalkylene oxide polymers, polycarboxylate polymers, and any combination thereof, most preferably, polycarboxylate polymers.

### Polycarboxylate Polymers.

Polycarboxylate polymers typically comprise at least one carboxy group-containing monomer. The carboxy group-containing monomers are typically selected from acrylic acid, methacrylic acid, fumaric acid, maleic acid, itaconic acid, aconitic acid, mesaconic acid, citraconic acid, methylenemalonic acid, salts thereof, anhydrides thereof, and any combination thereof.

Suitable polycarboxylate polymers include polyacrylate homopolymer having a molecular weight of from 4,000 Da to 9,000 Da, or from 6,000 Da to 9,000 Da. Other suitable carboxylate polymers include copolymers of acrylic acid (and/or methacrylic acid) and maleic acid having a molecular weight of from 50,000 Da to 120,000 Da, or from 60,000 Da to 80,000 Da. The polyacrylate homopolymer and copolymer of acrylic acid (and/or methacrylic acid) and maleic acid are commercially available as Acusol 445 and 445N, Acusol 531, Acusol 463, Acusol 448, Acusol 460, Acusol 465, Acusol 497, Acusol 490 from Dow Chemicals, and as Sokalan CP 5, Sokalan CP 7, Sokalan CP 45, and Sokalan CP 12S from BASF.

Suitable polycarboxylate polymers also include polyitaconate homopolymers, such as Itaconix® DSP 2K™ sold by Itaconix, and Amaze SP available from Nouryon.

Suitable polycarboxylate polymers also include co-polymers comprising carboxy group-containing monomers and one or more sulfonate or sulfonic group-containing monomers. The sulfonate or sulfonic group containing monomers are typically selected from 2-acrylamido-2-methyl-1-propanesulfonic acid (AMPS), 2-methacrylamido-2-methyl-1-propanesulfonic acid, 3-methacrylamido-2-hydroxy-propanesulfonic acid, allysulfonic acid, methallysulfonic acid, 3-allyloxy-2-hydroxy-1-propanesulfonic acid, 2-methyl-2-propenen-1-sulfonic acid, styrenesulfonic acid, vinylsulfonic acid, 3-sulfopropyl acrylate, 3-sulfopropylmethacrylate, sulfomethylacrylamide, sulfomethylmethacrylamide and water soluble salts thereof.

Suitable polymers may comprise maleic acid, acrylic acid, and 3-allyloxy-2-hydroxy-1-propanesulfonic acid. Suitable polymers may comprise acrylic acid and 2-acrylamido-2-methyl-propane sulfonate, such as those sold under tradename Acusol 588 by Dow Chemicals, Sokalan CP50 by BASF, Aquatreat AR-545, Versaflex 310 and Versaflex 310-37 by Nouryon.

Suitable polymers include poly(itaconic acid-co-AMPS) sodium salt, such as Itaconix® TSI™ 322 and Itaconix® CHT™ 122 available from Itaconix.

Suitable polycarboxylate polymers also include co-polymers comprising carboxy group-containing monomers and other suitable monomers. Other suitable monomers are selected from esters and/or amide of the carboxy group-containing monomers, such as C₁-C₂₀ alkyl ester of acrylic acid; alkylene; vinyl ethers, such as methyl vinyl ether, styrene and any mixtures thereof. One specific preferred polymer family of this type is sold under tradename Gantrez by Ashland, which includes Gantrez An (alternating co-polymer of methyl vinyl ether and maleic anhydride), Gantrez S (alternating co-polymer of methyl vinyl ether and maleic acid), Gantrez ES (alternating co-polymer of methyl vinyl ether and maleic acid ester), Gantrez MS (alternating co-polymer of methyl vinyl ether and maleic acid salt).

Suitable polycarboxylate polymers also include polyepoxy succinic acid polymers (PESA). A most preferred polyepoxy succinic acid polymer can be identified using CAS number: 51274-37-4, or 109578-44-1. Suitable polyepoxy succinic acid polymers are commercially available from various suppliers, such as Aquapharm Chemicals Pvt. Ltd (commercial name: Maxinol 600); Shandong Taihe Water Treatment Technologies Co., Ltd (commercial name: PESA), and Sirius International (commercial name: Briteframe PESA).

Suitable polycarboxylate polymers may comprise a monomer having at least one aspartic acid group or a salt thereof, this polymer comprises at least 25 mol %, 40 mol %, or 50 mol %, of said monomer. A preferable example is sodium salt of poly(aspartic acid) having a molecular weight of from 2000 to 3000 g/mol which is available as Baypure® DS 100 from Lanxess. Suitable polyaspartates can be further modified.

### Surfactant System.

Typically, the surfactant system provides cleaning benefits, shine benefits, water drainage and drying benefits. The surfactant system can act to remove soil and suspend soil.

The surfactant system can comprise amphoteric surfactant, anionic surfactant, cationic surfactant, nonionic surfactant, zwitterionic surfactant, and any combination thereof. Most preferably, the surfactant system comprises nonionic surfactant.

The surfactant system typically comprises a surfactant, typically one or more, preferably two or more, or three or more, or four or more, or even five or more different types of surfactants, and preferably from 2 to 8, or 3 to 7, or 4 to 6 different types of surfactants.

The surfactant system may have a phase inversion temperature, as measured at a concentration of 1wt % in distilled water, between 20° C. and 70° C., preferably between 35° C. and 65° C. Phase inversion temperature is the temperature below which a surfactant system partitions preferentially into the water phase (typically as oil-swollen micelles), and above which the surfactant system partitions preferentially into the oil phase (typically as water swollen inverted micelles). Phase inversion temperature can be determined visually by identifying at which temperature cloudiness occurs. The phase inversion temperature of the surfactant system can be determined as follows: a solution containing 1wt % of the surfactant system, by weight of the solution in distilled water, is prepared. The solution is stirred gently before phase inversion temperature analysis to ensure that the process occurs in chemical equilibrium. The phase inversion temperature is taken in a thermostable bath by immersing the solutions in 75 mm sealed glass test tube. To ensure the absence of leakage, the test tube is weighed before and after phase inversion temperature measurement. The temperature is gradually increased at a rate of less than 1° C. per minute, until the temperature reaches a few degrees below the pre-estimated phase inversion temperature. Phase inversion temperature is determined visually at the first sign of turbidity.

The surfactant system is typically a low foaming surfactant system. Preferably, the surfactant system comprises a surfactant selected from:
(i) R—O-EOₓH, wherein R is a C₆-C₁₈ alkyl, and x is from 1 to 30; or
(ii) R—O-EOₓPO_{y}H, wherein R is a C₆-C₁₈ alkyl, x is from 1 to 20, and y is from 1 to 20; or
(iii) R—O—POₓEO_{y}H, wherein R is a C₆-C₁₈ alkyl, x is from 1 to 20, and y is from 1 to 20; or
(iv) R—O— EOₓPO_{y}EO_{z}H, wherein R is a C₆-C₁₈ alkyl, x is y from 1 to 20, y is from 1 to 20, and z is from 1 to 20; or
(v) R—O— POₓEO_{y}PO_{z}H, wherein R is a C₆-C₁₈ alkyl, x is from 1 to 20, y is from 1 to 20, and z is from 1 to 20; or
(vi) HO— EOₓPO_{y}EO_{z}H, wherein, x is from 1 to 50, y is from 1 to 50, and z is from 1 to 50; or
(vii) HO— POₓEO_{y}PO_{z}H, wherein x is from 1 to 50, y is from 1 to 50, and z is from 1 to 50; or
(viii) R—O-EOₓBO_{y}H, wherein R is a C₆-C₁₈ alkyl, x is from 1 to 20, and y is from 1 to 20; or
(ix) R—O—BOₓEO_{y}H, wherein R is a C₆-C₁₈ alkyl, x is from 1 to 20, and y is from 1 to 20; or
(x) any combination thereof.

For the above surfactants (i) to (v) above, the alkyl moiety can be linear or branched, and can be derived from a guerbet alcohol, or can derived from an oxo-alcohol.

Suitable surfactants are non-ionic surfactants.

A suitable surfactant has the formula: R—O-EOₓH, wherein R is a C₆-C₁₈ alkyl, and x is from 1 to 30. Suitable surfactants are Lutensol AO series of surfactants from BASF and Lutensol TO series of surfactants from BASF.

A suitable surfactant has the formula: R—O-EOₓPO_{y}H, wherein R is a C₆-C₁₈ alkyl, x is from 1 to 20, and y is from 1 to 20. Suitable surfactants are Dehypon LS series of surfactants from BASF.

A suitable surfactant has the formula: R—O—PO_{y}EOₓH, wherein R is a C₆-C₁₈ alkyl, x is from 1 to 20, and y is from 1 to 20. Suitable surfactants are Ecosurf EH series of surfactants from Dow.

A suitable surfactant has the formula: R—O— EOₓPO_{y}EOₓH, wherein R is a C₆-C₁₈ alkyl, each x is independently from 1 to 20, and y is from 1 to 20. A suitable surfactant is Plurafac LF403 from BASF.

A suitable surfactant has the formula: R—O— PO_{y}EOₓPO_{y}H, wherein R is a C₆-C₁₈ alkyl, x is from 1 to 20, and each y is independently from 1 to 20. A suitable surfactant is Plurafac SLF180 from BASF.

A suitable surfactant has the formula: HO— EOₓPO_{y}EOₓH, wherein, each x is independently from 1 to 50, and y is from 1 to 50. Suitable surfactants are the Pluronic PE series of surfactants from BASF, and the Tergitol L series of surfactants from Dow.

A suitable surfactant has the formula: HO— PO_{y}EOₓPO_{y}H, wherein x is from 1 to 50, and each y is independently from 1 to 50. Suitable surfactants are the Pluronic RPE series of surfactants from BASF.

Other suitable surfactants include hydroxy mixed ether surfactants. The hydroxy mixed ether surfactants can be modified and/or endcapped. Suitable hydroxy mixed ether surfactants are Dehypon E127 and Dehypon GRA, both from BASF.

A suitable surfactant is amine oxide. A suitable surfactant is betaine. A suitable surfactant is an anionic surfactant selected from alkyl ether sulphates, alkyl sulphates, alkyl sulphonates, and any combination thereof.

### Other Ingredients.

Other suitable ingredients include aesthetic ingredients, fillers, glass care ingredients, metal care ingredients, perfumes, solvents, suds control agents, and any combination thereof.

Suitable fillers include sulphate salts. Suitable sulphate salts are alkali metal salts of sulphate and/or alkaline earth metal salts of sulphate. Preferred sulphate salts are selected from magnesium sulphate, sodium sulphate, and any combination thereof, most preferably sodium sulphate.

Suitable glass care ingredients include zinc-containing compounds. Suitable zinc-containing compounds include hydrozincite.

Suitable metal care ingredients include benzotriazole (BTA), tolyltriazole (TTA), their salt-forms, and any combination thereof. Preferred salt-forms are sodium forms of BTA and TTA.

Suitable solvents include alkanolamines, polyethers, polyols, and any combination thereof.

Suitable alkanolamines are selected from monoethanolamine, diethanolamine, triethanolamine, and any combination thereof.

Suitable polyethers are selected from glycerol ethers, polyethyleneglycol (PEG), polypropyleneglycol (PPG), glycol ethers, and any combination thereof. Suitable glycol ethers are the E-series and P-series of glycol ethers from Dow.

Suitable polyols are selected from propanediol, glycerol, sorbitol, and any combination thereof.

The solvent can act as a process aid and/or a benefit agent.

### Water-Insoluble Packaging.

The water-insoluble packaging is preferably in the form of a multi-compartment cartridge.

### A Multi-Compartment Cartridge.

The multi-compartment cartridge is suitable for auto-dosing into an automatic dishwashing appliance. In this manner, typically the cartridge can be docked into a receiving section that is present in the automatic dishwashing appliance. The receiving section may be an integral part of the appliance. Alternatively, the receiving section can be part of a separate stand-alone device that is placed in the treatment chamber of the appliance. The cartridge comprises the composition of the present invention. The first liquid component and second liquid component are contained within separate compartments of the cartridge. If additional liquid components are present, then all the liquid compartments are contained within separate compartments of the cartridge.

The cartridge is typically capable of separately dosing a controlled amount of liquid component from the various separate compartments at different times. In this manner, the separate liquid components can be auto-dosed into the treatment chamber of the automatic dishwashing appliance at different times, such as during the pre-wash stage, main wash stage and/or rinse stage of the treatment cycle.

### Method of Using the Composition.

The composition of the present invention is typically auto-dosed into an automatic dishwashing appliance. Typically, this method of treating dishware in an automatic dishwashing appliance comprises the steps of introducing the liquid components in a specific order.

Typically, the treatment cycle of the automatic dishwashing appliance comprises a pre-wash stage, which is followed by a main wash stage, which is followed by a rinse stage.

Preferably, the first liquid component is automatically dosed into the treatment chamber of the automatic dishwashing appliance during the rinse stage, preferably at the beginning of the rinse stage.

Preferably, the second liquid component is automatically dosed into the treatment chamber of the automatic dishwashing appliance during the main wash stage and/or during the rinse stage, preferably during both the main wash stage and the rinse stage, more preferably at the beginning of the main wash stage and at the beginning of the rinse stage.

If present, the third liquid component is automatically dosed into the treatment chamber of the automatic dishwashing appliance during the prewash stage and/or the main wash stage, preferably during both the prewash stage and the main wash stage, more preferably at the beginning of the pre-wash stage and at the beginning of the main wash stage.

If present, the fourth liquid component is automatically dosed into the treatment chamber of the automatic dishwashing appliance during the prewash stage and/or the main wash stage, preferably during both the prewash stage and the main wash stage, more preferably at the beginning of the pre-wash stage and at the beginning of the main wash stage.

### Examples

Automatic dishwashing compositions were made as detailed herein below.

### I. Preparation of Test Compositions

Liquid automatic dishwashing compositions A, B and C were prepared as detailed below:

| | A | B | C |
|---|---|---|---|
| Liquid Automatic Dishwashing Composition | wt % | | |
| Lutensol ® TO7 | 2.38 | | 50 |
| (non-ionic surfactant supplied by BASF) | | | |
| Plurafac ® SLF180 | 2.38 | | 50 |
| (non-ionic surfactant supplied by BASF) | | | |
| PAP (Phthalimidoperoxycaproic acid) | 9.52 | 10 | |
| Water and processing aids | 85.72 | 90 | |
| pH of neat composition measured at 20° C. | 5.35 | 3.4 | 8.6 |

### II. Test Items

The following items were sourced and added to each automatic dishwasher.

| | | | Number of Replicates |
|---|---|---|---|
| | | | added and position |
| Test Item | Supplier | Description | machine |
| Libbey Glasses | Artis | Libbey Straight sided Collins | 3 - Top rack |
| | | 29 cl drinking glasses - | |
| | | Libbey code 918823 | |
| US Acrylic | Mistral Brands Ltd | Long drink glasses made of | |
| Plastic Tumblers | | the plastic styrene- | |
| | | acrylonitrile resin (SAN). | |

### III. Test Wash Procedure

Automatic Programable Dishwasher: Miele, model GSL2
Wash volume: 5000 ml
Stage 1 Wash Water temperature: 45° C. (10 minutes)
Stage 2 Wash Water temperature: 45° C. (10 minutes)
Rinse Wash Water temperature: 15° C. (2 minutes)
Water hardness: 21 gpg
Stage 1 composition addition: Added at the start of stage 1.
Stage 2 composition addition: Added at the start of stage 2.

### Shine Performance

The stage 1 compositions were added to the automatic dishwasher at the start of stage 1. The stage 2 compositions were added to the automatic dishwasher at the start of stage 2.

| | Stage 1 composition | Stage 2 composition |
|---|---|---|
| Example A | 5.25 g Composition A | 5.25 g Composition A |
| (comparative) | | |
| Example B | 10 g Composition B | 0.5 g Composition C |

A dishwasher was loaded with the items as detailed above which were washed using as described. After running 10 consecutive cycles, the glass and plastic tumblers were then photographed against a black background and the images were analyzed using computer aided software. A spot is defined as a circular cluster larger than 4 pixels with higher gray scale (4 units) versus the background, while grit is defined as a circular cluster smaller than 4 pixels with higher gray scale (4 units) versus the background. A lower spot and grit count is desired.

| | Libbey Glass | Plastic Tumbler | |
|---|---|---|---|
| | Grit Count | Spot Count | Grit Count |
| Example A (comparative) | 619 | 383 | 762 |
| Example B | 452 | 86 | 316 |

As shown in the table above, Example B according to the invention provides lower spotting and grit counts and therefore superior shine versus the comparative Example A.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

As used in this specification and the claims that follow, the articles “a”, “an”, and “the” include singular and plural references unless the context clearly dictates otherwise. As such, the terms “a” or “an”, “one or more” and “at least one” can be used interchangeably herein. Thus, for example, “a component” may include one or more components unless the reference is specifically indicated as being singular.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An automatic dishwashing detergent composition suitable for auto-dosing into an automatic dishwashing appliance, the composition comprising a combination of at least a first liquid component and a second liquid component that are contained separately from one another within a water insoluble packaging, wherein:
(a) the first liquid component:
(i) comprises at least 5.0wt %, by weight of the first liquid component, phthalimidoperoxycaproic acid bleach;
(ii) comprises greater than 20 wt %, by weight of the first liquid component, water; and
(iii) has a pH of less than 7.0, when measured neat at a temperature of 20° C.; and
(b) the second liquid component comprises greater than 50 wt %, by weight of the second liquid component, non-ionic surfactant.

2. The composition according to claim 1, wherein the pH of the first liquid component is in the range of from 2.0 to 5.0, when measured neat at a temperature of 20° C.

3. The composition according to claim 1, wherein the first liquid component comprises from 7.5 wt % to 30 wt %, by weight of the first liquid component, of the phthalimidoperoxycaproic acid bleach.

4. The composition according to claim 1, wherein the first liquid component comprises from 50 wt % to less than 95 wt %, by weight of the first liquid component, of the water.

5. The composition according to claim 1, wherein the first liquid component is free of enzyme.

6. The composition according to claim 1, wherein the first liquid component comprises xanthan gum.

7. The composition according to claim 1, wherein the second liquid component comprises greater than 67 wt %, by weight of the second liquid component, of the nonionic surfactant.

8. The composition according to claim 1, wherein the second liquid component is anhydrous.

9. The composition according to claim 1, wherein the second liquid component comprises a surfactant selected from:
(i) R—O-EOₓH, wherein R is a C₆-C₁₈ alkyl, and x is from 1 to 30; and/or
(ii) R—O— POₓEO_{y}PO_{z}H, wherein R is a C₆-C₁₈ alkyl, x is y from 1 to 20, y is from 1 to 20, and z is from 1 to 20.

10. The composition according to claim 1, wherein the second liquid component comprises from 10 wt % to 30 wt %, by weight of the second liquid component, of the dipropyleneglycol.

11. The composition according to claim 1, wherein the second liquid component comprises aminopolycarboxylic acid and/or salt thereof builder.

12. A multi-compartment cartridge that is suitable for auto-dosing into an automatic dishwashing appliance, wherein the cartridge comprises the composition according to claim 1, wherein the first liquid component and the second liquid component are contained within separate compartments of the cartridge.
